(19) United States
(12) Patent Application Publication
(10) Pub. No.: US 2005/0253851 A1
(43) Pub. Date: Nov. 17, 2005

(54) System for providing virtual space, a virtual space providing server and a virtual space providing method for advancing communication between users in virtual space

(75) Inventor: Hironori Tsukamoto, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/128,394

(22) Filed: May 13, 2005

(30) Foreign Application Priority Data
May 14, 2004 (JP) 2004-145227

(51) Int. Cl. G06T 15/70; G06T 13/00

(52) U.S. Cl. 345/473

(57) ABSTRACT

Based on the positions of characters that are supplied from a character position management unit, a communication control unit monitors whether or not another character is within a prescribed sphere that takes the position of a particular character as its center. The communication control unit permits the communication of information between the information communication unit of the user terminal device that corresponds to the particular character and the information communication unit of another character when the other character is within the prescribed sphere that takes the particular character as center. The communication control unit further automatically puts into effect a speech conference function that is realized between the information communication unit of the user terminal device that corresponds to the particular character and the information communication unit of the other character.

### BACKGROUND OF THE INVENTION

1. Field of the Invention

The present invention relates to a virtual space-providing system, a virtual space-providing server, and a virtual space-providing method.

2. Description of the Related Art

Remarkable progress is now being made in information communication technology. This progress in information communication technology allows participants living in different countries to manipulate game characters (players) that appear in virtual space that is provided by a shared game server. Further, with the development of VoIP (Voice-over Internet Protocol) technology, an ISP (Internet Services Provider) can now hold a network for handling VoIP.

Still further, with the popularization of ADSL (Asymmetric Digital Subscriber Lines) and optical fiber, an Internet environment having a broad frequency bandwidth can now be provided to ordinary households.

With the advances in information communication technology, online shopping by means of Web pages on the Internet has now come into widespread use. JP2002-63270-A describes a virtual store server system that provides to a user's terminal device a virtual store that corresponds to an actual store.

Online shopping systems are now being proposed that can provide online shopping in which the user is able to purchase articles just as if he or she were in an actual store.

For example, an online shopping system is known in which a character such as a character in a game is displayed in a virtual store. In this online shopping system, the user causes the character to move within the virtual store and purchase articles in the virtual store.

In yet another known online shopping system, a plurality of characters that correspond to a plurality of users are displayed in a virtual store. In this online shopping system, the users that are manipulating the plurality of characters are able to communicate with each other.

JP2003-30469-A discloses another commodity sales system in which a virtual department store, which is in three-dimensional virtual space that is provided by a server device, is displayed on a plurality of user terminal devices that are connected to the server device. In this commodity sales system, the plurality of characters, which correspond to each of the users of the plurality of user terminal devices, are displayed in the virtual department store.

In this commodity sales system, the users are able to use letters (written characters) to converse with other users who are manipulating the characters that are in the same virtual store.

JP08-87488-A discloses a cyberspace system in which virtual space, which is provided by a server device, is displayed on a plurality of user terminal devices that are connected to this server device. This cyberspace system displays in this virtual space a plurality of characters that correspond to each of the users of the plurality of user terminal devices.

By designating another character in the same space, a user is able to converse by voice with another user who is manipulating the designated character or with a service provider that is manipulating the designated character.

JP2002-157209-A discloses a searching system in which characters on a screen that displays three-dimensional virtual space are able to chat with other characters that are on the same screen.

However, the systems, which are disclosed in JP2003-30469-A, JP08-87488-A and JP2002-157209-A, have a number of problems.

In the commodity sales system that is disclosed in JP2003-30469-A, communication can be realized only between users who are manipulating characters that are in the same virtual store, and as a result, conversations that can be realized in the real world, specifically, conversations that occur before entering a store, cannot be realized.

In the cyberspace system of JP08-87488-A, conversing with another user requires the user to take the trouble of designating the character of the other user.

In the search system of the JP2002-157209-A, characters that are displayed on a screen only can chat with characters that are displayed on the same screen. In other words, a character that is displayed on a screen is not able to chat with a character that is not shown on the screen.

Thus, if the position of a particular character in three-dimensional virtual space does not change, but the characters that are displayed on the same screen as the particular character change, depending on whether the particular character is displayed in the center of the screen or displayed in the corner of the screen, the characters with whom chatting is possible will also change. This phenomenon would not occur in the real world.

### SUMMARY OF THE INVENTION

It is an object of the present invention to provide a virtual space-providing system, a virtual space-providing server, and a virtual space-providing method that enable users that manipulate characters in virtual space to communicate as in the real world.

To achieve the above-described object, the virtual space-providing system of the present invention includes a plurality of user terminal devices and a virtual space-providing server.

The plurality of user terminal devices each includes an information communication unit.

The virtual space-providing server places in virtual space a different character that corresponds to each user terminal device. The virtual space-providing server stores the correspondence between the user terminal devices and the characters. The virtual space-providing server, upon receiving connection requests from each of the user terminal devices by way of communication lines, arranges in virtual space the characters that correspond to the user terminal devices that supplied the connection requests. The virtual space-providing server then provides image information to each of the plurality of user terminal devices by way of a communication line, this image information indicating the images in the vicinity of the characters that correspond to each of the user terminal devices.

The virtual space-providing server includes a character position management unit, a determination unit, and an information communication control unit.

The character position management unit manages the positions of the plurality of characters within virtual space.

The determination unit, based on the positions in virtual space of the plurality of characters that are managed by the character position management unit, determines whether or not another character is in the region surrounding a prescribed character, this prescribed character being any of the plurality of characters.

When the determination unit has determined that another character is in the area surrounding the prescribed character, the information communication control unit permits the communication of information between the information communication unit of the user terminal device that corresponds to the prescribed character and the information communication unit of the user terminal device that corresponds to the other character.

When the determination unit has determined that another character is not in the area surrounding the prescribed character, the information communication control unit prohibits the communication of information between the information communication unit of the user terminal device that corresponds to the prescribed character and the information communication unit of the user terminal device that corresponds to the other character.

The user of a user terminal device that corresponds to the prescribed character thus, by becoming the prescribed character, is able to realize communication in virtual space that resembles communication in the real world. More specifically, the user is able to communicate in virtual space with people close to the user, that is, with the users of user terminal devices that correspond to other characters.

The information communication unit preferably communicates speech information.

In addition, the information communication unit preferably communicates moving picture information.

Further, the information communication unit preferably communicates still picture information.

Still further, the information communication unit preferably communicates speech information, moving picture information, and still picture information.

Finally, the virtual space-providing server preferably moves characters, which are arranged in the virtual space, based on movement instruction requests that are supplied from the user terminal devices that correspond to these characters.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram showing the virtual space-providing system in one embodiment of the present invention;

FIG. 2 is a block diagram showing an example of a user terminal device;

FIG. 3 is a block diagram showing an example of a three-dimensional ISP city server;

FIG. 4 is a function block diagram showing an example of a three-dimensional ISP city server;

FIG. 5 is a block diagram showing an example of a communication control unit;

FIG. 6 is a flow chart for explaining the operation of a virtual space-providing system; and

FIG. 7 is an explanatory view showing an example of the region surrounding a character.

### DETAILED DESCRIPTION OF THE PREFERRED EMBODIMENTS

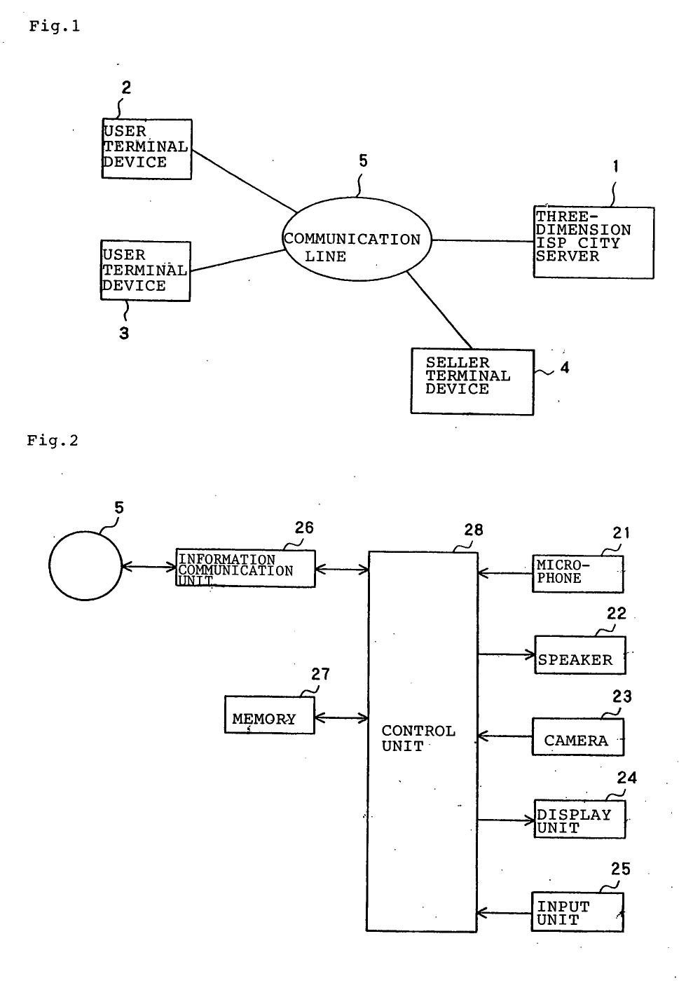

In FIG. 1, the virtual space-providing system includes: three-dimensional ISP city server (hereinbelow referred to as simply “server”) 1, user terminal device 2, user terminal device 3, and seller terminal device 4.

Server 1 communicates with seller terminal device 4 and user terminal devices 2 and 3 by way of communication line 5. Communication line 5 is, for example, the Internet. User terminal device 2 communicates with user terminal device 3 by way of communication line 5. The user terminal devices may be in a plurality that is not limited to two devices.

Server 1 is one example of a virtual space-providing server.

Server 1 places in virtual space each of different characters in correspondence with each of the user terminal devices 2 and 3. Server 1 stores these correspondences, specifically, the correspondences between the user terminal devices and the characters.

Server 1 receives connection requests from each of the plurality of user terminal devices 2 and 3 by way of communication line 5.

Server 1 creates virtual space.

Upon receiving connection requests, server 1 arranges in virtual space the plurality of characters that correspond to each of the user terminal devices that have supplied the connection requests. Server 1 moves this plurality of characters based on movement instruction requests that are supplied from the user terminal devices that correspond to these characters. In the present embodiment, moreover, server 1 uses a three-dimensional virtual city as the virtual space.

Server 1 provides, by way of communication line 5, to each of the plurality of user terminal devices that have supplied the connection requests, image information that indicates the images of the neighborhoods of each of the characters that correspond to the user terminal devices.

The images preferably include: the three-dimensional virtual city in the vicinities of the characters that correspond to the user terminal devices; and the other characters that are in the vicinities of these characters.

User terminal devices 2 and 3 are, for example, personal computers that can be connected to communication line 5. User terminal devices 2 and 3 include a Web browser that is an application program. In the present embodiment, user terminal devices 2 and 3 use a Web browser to communicate with server 1. The plurality of user terminal devices (user terminal devices 2 and 3) each includes an information communication unit.

These information communication units may use a microphone and speaker to communicate speech information. In addition, these information communication units may use a camera and display unit to communicate moving picture information. Further, these information communication units may use a still picture input unit and still picture output unit to communicate still picture information.

In addition, these information communication units may communicate speech information and moving picture information. Alternatively, these information communication units may communicate speech information and still picture information. Or, these information communication units may communicate moving picture information and still picture information. Finally, these information communication units may communicate speech information, moving picture information, and still picture information.

The still picture input unit may be an input unit that accepts figures and characters (letters) that have been supplied by a user as information for an electronic whiteboard. Alternatively, the still picture output unit may be a display unit for displaying an electronic whiteboard in which figures and characters that have been supplied by a user are displayed.

Or, the still picture input unit may be a designation unit for designating a display screen (or a file) that is displayed by an application (program) that is provided in the user terminal device. Alternatively, the still picture output unit may be a display unit for displaying a display screen (or file) that is designated by the designation unit.

The still picture input unit may include the above-described input unit and the above-described designation unit, and the still picture output unit may include a display unit for displaying the electronic whiteboard and a display unit for displaying a display screen (or file) that has been designated by the above-described designation unit.

FIG. 2 is a block diagram showing an example of user terminal device 2. In the present embodiment, user terminal device 3 is assumed to have the same composition as user terminal device 2, and for this reason, a detailed explanation of user terminal device 3 is here omitted.

In FIG. 2, user terminal device 2 includes: microphone 21, speaker 22, camera 23, display unit 24, input unit 25, information communication unit 26, memory 27, and control unit 28.

Microphone 21 receives speech from a user. Speaker 22 supplies speech as output according to the speech information that has been supplied from control unit 28. Camera 23 captures images of a subject such as a user. Camera 23 supplies the moving picture information that has been obtained by this image capture to control unit 28. Display unit 24 displays an image according to image information that has been supplied from control unit 28. Input unit 25 includes a keyboard and mouse. Input unit 25 receives input from a user. Information communication unit 26 communicates various types of information with server 1 and user terminal device 3 by way of communication line 5. These various types of information are, for example, speech information, moving picture information, still picture information, or image information of the three-dimensional city.

Memory 27 is one example of a recording medium that can be read by a computer. Memory 27 includes ROM and RAM.

Various programs (applications) for prescribing the operation of user terminal device 2 are recorded in memory 27. For example, an application program for browsing the Internet, which is a browser, and application programs, which are different from the browser, are recorded in memory 27. One application, which is different from the browser, would be, for example, an application program for word processing.

In addition, memory 27 records, as appropriate, information and programs that are used by control unit 28 when control unit 28 executes various processes. Control unit 28 is, for example, a computer. Control unit 28 reads the programs that are recorded in memory 27. Control unit 28 carries out various processes by executing the programs that have been read.

As an example, when input unit 25 receives a connection request from a user for connection to server 1, control unit 28 causes information communication unit 26 to execute a connection request supply process for supplying this connection request to server 1 by way of communication line 5. In the present embodiment, the URL (Uniform Resource Locator) of server 1 is used as a connection request.

More specifically, when the browser has been started up and when input unit 25 receives the URL of server 1 from a user, control unit 28 causes information communication unit 26 to execute the connection request supply process. Alternatively, when information communication unit 26 receives image information from server 1, control unit 28 supplies this received image information to display unit 24.

Alternatively, control unit 28 controls the communication of information between information communication unit 26 and the information communication unit of another user terminal device to which server 1 allows information communication unit 26 to communicate information.

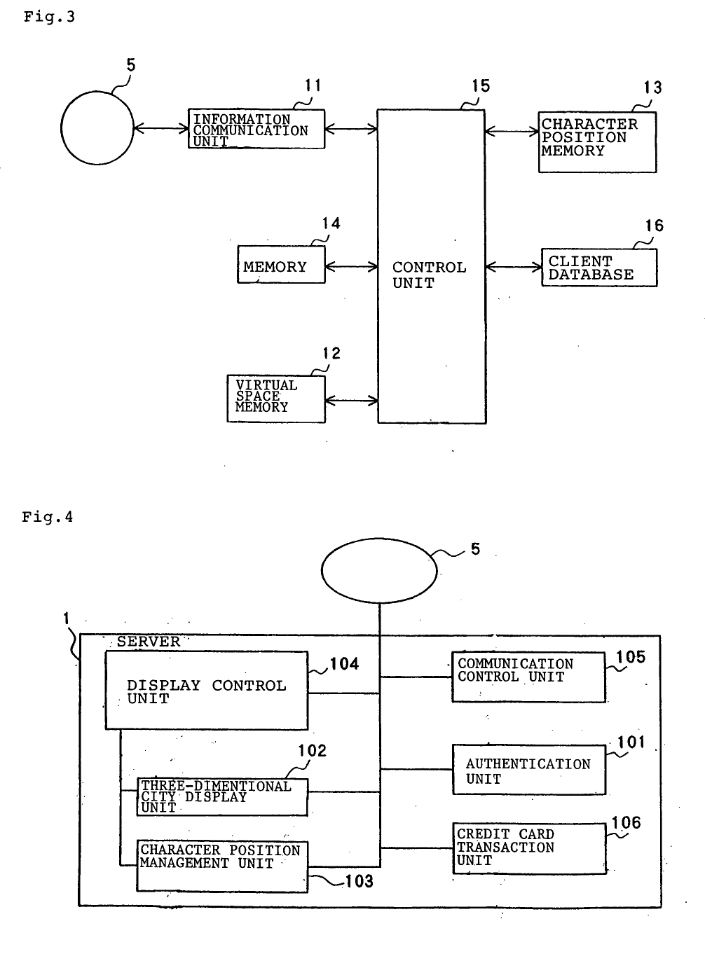

FIG. 3 is a block diagram showing an example of server 1.

In FIG. 3, server 1 includes: information communication unit 11, virtual space memory 12, character position memory 13, memory 14, control unit 15, and client database 16.

Information communication unit 11 communicates various types of information with seller terminal device 4 and user terminal devices 2 and 3 by way of communication line 5.

Virtual space memory 12 stores virtual space display information. The virtual space display information is information for displaying an actual city, for example, a city within a 5-kilometer radius that takes a station that actually exists as the center, as a three-dimensional virtual space by means of CG (Computer Graphics). X, Y and Z coordinate axes are established in the virtual space that is displayed by the virtual space display information. Positions in the virtual space can be specified by (X, Y, Z) coordinates. In addition, the virtual space display information may indicate a space that does not actually exist, for example, a city that does not actually exist.

Character position memory 13 stores the positions of characters in this virtual space. More specifically, character position memory 13 stores (X, Y, Z) coordinates that indicate the position of characters in the virtual space. Memory 14 is, for example, a recording medium that can be read by a computer. Programs for prescribing the operation of server 1 are recorded in memory 14.

Control unit 15 is, for example, a computer. Control unit 15 reads the programs that are stored in memory 14. Control unit 15 executes various functions by executing the programs that have been read. In addition, the functions that are executed by control unit 15 are described as functions that are executed by server 1.

Client database 16 stores information of the members who use server 1. Client database 16 stores the information on the user members of server 1 and the passwords of these user members that are related to each other. For example, the information on the user members of server 1 is the log-in IDs of the user members.

Client database 16 may also store related information on the user members: the user members' log-in IDs, user members' passwords, user members' credit card numbers, user members' telephone numbers, and user members' addresses.

FIG. 4 is a function block diagram showing the functions that are realized by server 1.

In FIG. 4, server 1 includes: authentication unit 101, three-dimensional city display unit 102, character position management unit 103, display control unit 104, communication control unit 105, and credit card transaction unit 106. Authentication unit 101 authenticates the user terminal devices that log in to server 1.

Authentication unit 101 supplies input screen information by way of communication line 5 to the user terminal device that accessed the URL of server 1. In addition, the input screen information shows an authentication screen that prompts the input of the log-in ID and password.

Upon receiving the input screen information, a user terminal device displays this authentication screen. The user of the user terminal device enters his or her log-in ID and password to the user terminal device based on the authentication screen. The user terminal device then supplies the entered log-in ID and password to server 1 by way of communication line 5.

Authentication unit 101 of server 1 collates the log-in ID and password with combinations of log-in IDs and passwords that are stored in client database 16. If the combination of log-in ID and password, which have been supplied from the user terminal device, matches the combination of log-in ID and password that is stored in client database 16, authentication unit 101 allows the user terminal device that supplied the log-in ID and password to log in to server 1. Authentication unit 101 further registers, in a user list that is provided in authentication unit 101, the user information (for example, the log-in ID) that indicates the user of the user terminal device that has been logged in.

However, if the combination of log-in ID and password, which has been supplied from the user terminal device, does not match with the combination of log-in ID and password that is stored in client database 16, authentication unit 101 supplies the user terminal device that supplied the log-in ID and password with “log-in execution denied” information indicating that log-in cannot be executed on server 1.

Authentication unit 101 preferably allows user terminal devices to transmit log-in IDs and passwords by an SSL (Secure Socket Layer). In this case, the log-in IDs and passwords can be transmitted safely.

Authentication unit 101 also supplies the user terminal device that has logged in to server 1 with an HTML (Hypertext Markup Language) document that causes the browser of a user terminal device to display a log-out button.

When the user of a user terminal device that has logged in to server 1 clicks on the log-out button, a log-out request is supplied to server 1.

Upon receiving this supplied log-out request, authentication unit 101 carries out processing for the log-out of the user terminal device and deletes the user ID (log-in ID) of the user that has logged out from the user list.

Three-dimensional city display unit 102 creates virtual city display data. The virtual city display data are data that cause a portion of the three-dimensional virtual city to be displayed by means of CG on the user terminal devices that have logged in. This three-dimensional virtual city is indicated by virtual space display information that is stored in virtual space memory 12.

Characters, which correspond to the user terminal devices that have logged in, are arranged in the three-dimensional virtual city.

Three-dimensional city display unit 102 uses, as virtual city display data, image information that indicates the surroundings of characters (for example, the scene will occur in the direction of designated by the characters) that correspond to the user terminal devices. As a result, the three-dimensional virtual city, which is displayed on each user terminal device, is the field of vision of the character that corresponds to that user terminal device.

Three-dimensional city display unit 102 receives command data from display control unit 104. The command data are transmitted from the user terminal devices. The command data indicate operations (for example, the operation of a character opening a door) that a character will perform in the virtual space city.

Three-dimensional city display unit 102 generates, as virtual city display data, a moving picture such as for opening a door in the virtual city in accordance with the received command data.

Character position management unit 103 generates character display data for displaying characters (players). The user terminal devices that have logged in manipulate these characters. In addition, these characters are arranged in the virtual city.

When, for example, users A, B, and C manipulate each of their characters in a virtual city in the present embodiment, character position management unit 103 operates as follows:

Character position management unit 103 displays the characters of users B and C on the browser screen of the user terminal device of user A without displaying the character of user A. As a result, the characters of other users, which are in the area designated by the character that is manipulated by user A, are displayed on the browser screen of the user terminal device of user A. Character position management unit 103 has (X, Y, Z) coordinates that indicate the positions of each character within the virtual city. Based on the (X, Y, Z) coordinates of each character, character position management unit 103 manages the positions of each character and the distances (the perspective) between the characters and buildings. Character position management unit 103 causes the characters on the screen to execute movements according to input (command data) that is provided from user terminal devices.

In addition, the command data are commands for causing the characters on the screen to execute movements such as “open a door,” “run,” and “grasp.” In addition, the command data have been defined beforehand for the users. For example, any input that has been defined beforehand for users is a command defined by “Enter+Enter.”

More specifically, when a user supplies command data to a user terminal device, the supplied command data are transmitted from the user terminal device to server 1.

Character position management unit 103 receives the transmitted command data by way of display control unit 104. Character position management unit 103 causes the character, which corresponds to the user terminal device that has transmitted the command data, to execute movements according to the received command data.

Movements of a character according to command data are preferably executed when, for example, a character manipulates buildings (such as doors) of the city and when the character designates any article while shopping.

Display control unit 104 synthesizes the virtual city display data, which have been generated in three-dimensional city display unit 102, and the character display data, which have been generated by character position management unit 103, into one screen based on the (X, Y, Z) coordinates of the characters. Display control unit 104 generates image information that indicates this synthesized screen. Display control unit 104 supplies this generated image information to the user terminal devices by way of communication line 5. Display control unit 104 further supplies the command data, which have been supplied from the user terminal devices, to three-dimensional city display unit 102 and character position management unit 103.

Communication control unit 105 uses the (X, Y, Z) coordinates of the characters that are managed by character position management unit 103 in order to control communication such as a conversation between a particular character and other characters that are within a sphere, which has a predetermined radius and takes the particular character as center.

Communication control unit 105 takes the characters that are within this sphere as one group, and enables N-to-N (in which the voices of N speakers are transmitted to the same N listeners) conversation (conference) between the members in the group.

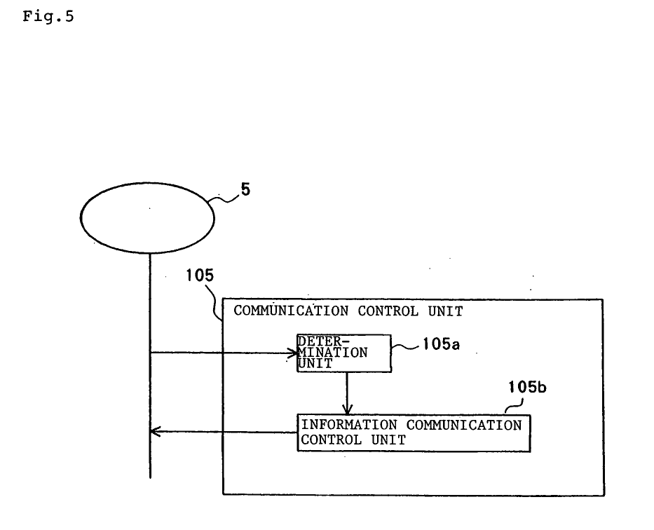

FIG. 5 is a block diagram showing an example of communication control unit 105.

In FIG. 5, communication control unit 105 includes determination unit 105a and information communication control unit 105b.

Based on the (X, Y, Z) coordinates of characters that are managed by character position management unit 103, determination unit 105a determines whether or not other characters are in the area surrounding a prescribed character. For example, the area may be a sphere that has a predetermined radius and takes the prescribed character as its center.

When determination unit 105a has determined that other characters are in the area surrounding the prescribed character, information communication control unit 105b permits the communication of information between the information communication unit of the user terminal device that corresponds to the prescribed character, and the information communication units of the user terminal devices that correspond to the other characters.

On the other hand, when determination unit 105a determines that no characters are within the area surrounding the prescribed character, information communication control unit 105b prohibits the communication of information between the information communication unit of the user terminal device that corresponds to the prescribed character and the information communication units of user terminal devices that correspond to the other characters.

The communication of information that is controlled by communication control unit 105 (specifically, information communication control unit 105b) can be, for example, the communication of speech information for executing a Web speech conference function.

A Web speech conference function is a function for distributing, by way of server 1, speech, which is applied as input from the microphones that are provided in the user terminal devices of each member of a group, to the user terminal devices of each member. The speech information is distributed by using the IP telephone function of VoIP that server 1 supplies together with services such as ADSL.

The communication of information that is controlled by communication control unit 105 (more specifically, information communication control unit 105b) can be the communication of image information for executing, for example, a whiteboard function, an application-share function, a video conference function, and a file transfer function, or any one, two, or three of these functions.

As an example, when specific input (for example, Ctr+•[• being arbitrary]) from the user terminal device of a member of a group is supplied, communication control unit 105 (more specifically, information communication control unit 105b) presents a pop-up display of a tool screen (HTML) on the user terminal device.

When the user terminal device displays the tool screen, the user of the user terminal device clicks on the desired execution button from among the execution buttons having the appropriate function (whiteboard function, application-share function, video conference function, and file transfer function) that are displayed on the tool screen.

This user terminal device supplies to server 1 function execution information that indicates that the function indicated by the desired function button is to be executed.

Upon receiving the function execution information, communication control unit 105 (more specifically, information communication control unit 105b) of server 1, causes the information communication units of the user terminal devices of each member to execute the function that is indicated by the received function execution information.

The whiteboard function has the function of causing a whiteboard screen to pop up on a user terminal device when the whiteboard function execution button is clicked on. The whiteboard screen that has popped up displays: a screen for inscribing written characters and figures, a palette that can set various colors, a pen for painting, and a figure drawing tool for automatically displaying figures (such as squares and triangles).

The application share function has the function of causing an application share screen to pop up on a user terminal device when the application share function execution button is clicked on. The application share screen displays the names of other applications that are currently in operation on the user terminal device.

When the user clicks on the name of an application that is displayed on the application share screen, the display data of the application, which has been clicked, are transmitted to server 1.

Server 1 distributes the transmitted display data to the user terminal devices of other members of the group. The distributed display data displays the pop up screens of the other members on the terminal devices.

When members enter, for example, a change in numerical values to this popped up screen, input data that indicate this entry are distributed by way of server 1 to the user terminal devices of other members, whereby the user terminal devices of all members can display common application screens and can change the displayed data.

The file transfer function has the function of causing a file transfer screen to pop up on user terminal devices when the file transfer function execution button is clicked on. The file transfer screen displays the names of files that are stored in user terminal devices.

When a user clicks on the name of a file that is displayed on the file transfer screen, the file that has been clicked on is transmitted to server 1.

Server 1 distributes the transmitted file to the user terminal devices of other members, and the user terminal devices of other members cause a screen, which is indicated by the file that has been transmitted, to pop up.

The video conference function includes a function for causing a video conference screen to pop up on user terminal devices when the video conference function execution button is clicked on if cameras are connected to or mounted in the user terminal devices of members. Video data (moving picture data) that are provided by the camera is distributed to the user terminal devices of each member by way of server 1. The display unit of each user terminal device displays the moving picture according to the video data that have been distributed.

Credit card transaction unit 106 includes a function that causes a credit card number input screen for prompting input of a credit card number to pop up on a user terminal device when a user has entered information to input unit 25 indicating the purchase of an article.

When a user wishes to carry out a transaction such as purchasing an article that is offered by seller terminal device 4, the user operates his or her user terminal device in order to supply his or her log-in ID to seller terminal device 4. The user of seller terminal device 4 enters the log-in ID, which has been supplied from the user terminal device, to a screen that is displayed in the browser of seller terminal device 4. Then, the user of seller terminal device 4 clicks on the execution button that is displayed in the browser of seller terminal device 4. The screen that is displayed in the browser of seller terminal device 4 is supplied from server 1.

When the execution button is clicked on, seller terminal device 4 supplies the entered log-in ID to server 1.

Credit card transaction unit 106 of server 1 specifies the user based on the supplied log-in ID. Credit card transaction unit 106 transmits an HTML document, which indicates the credit card number input screen, to the user terminal device of the specified user.

Upon receiving the HTML document, the user terminal device causes the credit card number input screen to pop up on the browser.

The user enters the credit card number into the credit card number input screen and then uses the whiteboard function in order to enter a signature. The supplied credit card number and signature are transmitted to a transaction database that is held by seller terminal device 4. Then, the supplied credit card number and signature are used in processes such as demand for payment. Server 1 supports only the function of transmitting the data of the credit card number and signature to seller terminal device 4.

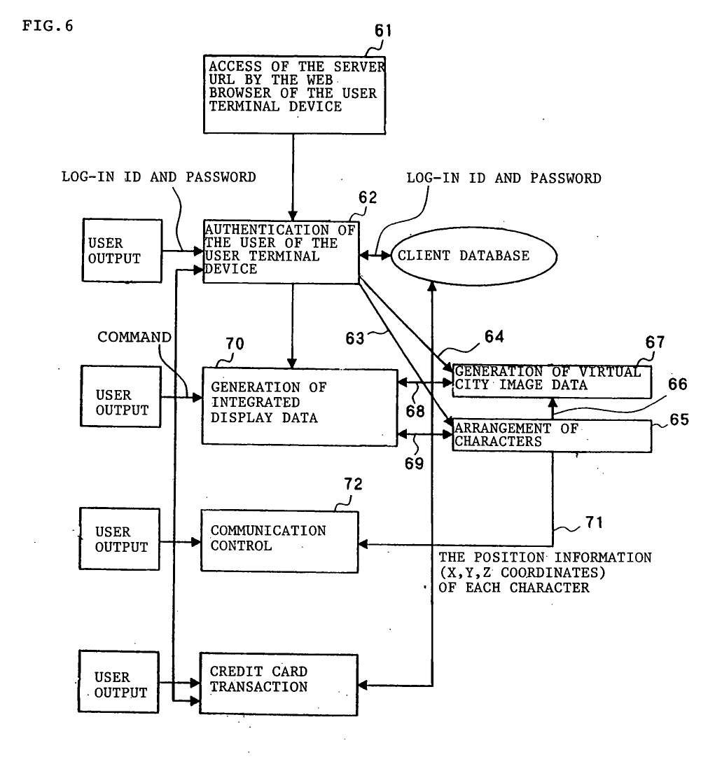

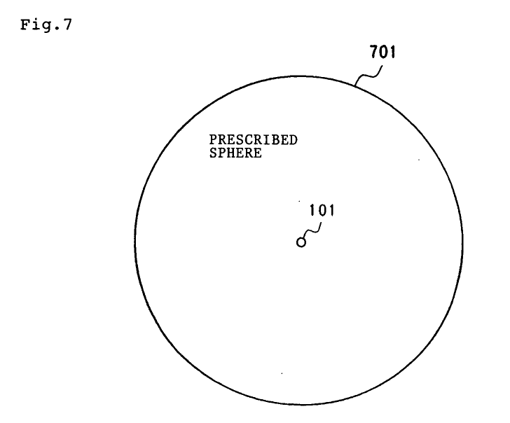

Explanation next regards the operation of the virtual space-providing system with reference to FIG. 6. In the following explanation, user terminal device 3 is assumed to have already logged in to sever 1, and explanation regards the log-in of user terminal device 2 to server 1 in this state.

In Step 61, upon receiving the URL of server 1 from the user, when the Web browser has started up, user terminal device 2 transmits a connection request to the server in order to access server 1.

Upon being accessed by user terminal device 2, server 1 executes Step 62. In Step 62, authentication unit 101 of server 1 verifies whether or not the user of user terminal device 2 is a member that has registered in advance.

More specifically, at first, authentication unit 101 supplies, to user terminal device 2 by way of communication line 5, input screen information that indicates an authentication screen prompting the input of a log-in ID and password.

Upon receiving the input screen information, user terminal device 2 displays the authentication screen. The user of user terminal device 2 enters his or her log-in ID and password to user terminal device 2 based on the displayed authentication screen. User terminal device 2 supplies the entered log-in ID and password to server 1 by way of communication line 5.

Authentication unit 101 collates the combination of log-in ID and password, which have been supplied by user terminal device 2, with combinations of log-in IDs and passwords, which are stored in client database 16.

If the combination of log-in ID and password, which have been supplied by user terminal device 2, does not match with any combination of log-in ID and password that is stored in client database 16, authentication unit 101 supplies log-in execution denied information to user terminal device 2 that supplied the log-in ID and password.

On the other hand, if the combination of log-in ID and password, which have been supplied by user terminal device 2, matches with a combination of log-in ID and password that is stored in client database 16, authentication unit 101 allows user terminal device 2 to log in to server 1.

Authentication unit 101 further adds the supplied log-in ID to a list of logged in users that is provided in authentication unit 101.

When allowing user terminal device 2 to log in to server 1, authentication unit 101 executes Step 63.

In Step 63, authentication unit 101 supplies user terminal device log-in notification, which indicates that user terminal device 2 has logged in to server 1, to character position management unit 103.

Upon completing Step 63, authentication unit 101 next executes Step 64.

In Step 64, authentication unit 101 supplies user terminal device log-in notification to three-dimensional city display unit 102.

Upon receiving the user terminal device log-in notification, character position management unit 103 executes Step 65.

In Step 65, character position management unit 103 arranges the character that corresponds to user terminal device 2 in an initial position in the virtual city that has been generated by three-dimensional city display unit 102. The initial position is indicated by (X, Y, Z) coordinates.

Upon the transmission of a movement instruction request from user terminal device 2, character position management unit 103 moves the character that corresponds to user terminal device 2 from the initial position and manages the position ([X, Y, Z] coordinates) of the character based on the movement instruction request.

In addition, character position management unit 103 also arranges the character that corresponds to user terminal device 3 that has already logged into server 1 at any location in the virtual city. Character position management unit 103 also moves the character that corresponds to user terminal device 3 from the initial position to any position and manages the position ([X, Y, Z] coordinates) of the character based on movement instruction requests that are transmitted from user terminal device 3.

After completing Step 65, character position management unit 103 executes Step 66.

In Step 66, character position management unit 103 supplies position information ([X, Y, Z] coordinates) of the character that corresponds to user terminal device 2 to three-dimensional city display unit 102.

Upon receiving from character position management unit 103 the position information of the character that corresponds to user terminal device 2, three-dimensional city display unit 102 executes Step 67.

In Step 67, three-dimensional city display unit 102 generates virtual city display data that indicate the virtual city that is in the vicinity of the character that corresponds to user terminal device 2. The virtual city display data indicates the part of the virtual city that is in the area designated by the character that corresponds to user terminal device 2.

After generating the virtual city display data, three-dimensional city display unit 102 executes Step 68.

In Step 68, three-dimensional city display unit 102 supplies the generated virtual city display data to display control unit 104.

After supplying the position information of the character that corresponds to user terminal device 2 to three-dimensional city display unit 102, character position management unit 103 executes Step 69.

In Step 69, character position management unit 103 supplies position information of the character that corresponds to user terminal device 3 and display data of the character that corresponds to user terminal device 3 to display control unit 104.

Display control unit 104, upon receiving the virtual city display data that have been supplied from three-dimensional city display unit 102, the position information of the character that corresponds to user terminal device 3 and the display data of the character that corresponds to user terminal device 3 that have been supplied from character position management unit 103, executes Step 70.

In Step 70, display control unit 104 determines, based on the (X, Y, Z) coordinates of the virtual city that are indicated by the virtual city display data and the (X, Y, Z) coordinates of the position information of the character that corresponds to user terminal device 3, whether or not the character that corresponds to user terminal device 3 is in the virtual city that is indicated by the virtual city display data.

If display control unit 104 determines that the character that corresponds to user terminal device 3 is in the virtual city, display control unit 104 integrates the virtual city display data with the display data of the character that corresponds to user terminal device 3 such that the character that corresponds to user terminal device 3 is displayed in the position of the virtual city that is indicated by the position information of the character. Then, display control unit 104 generates integrated display data.

Display control unit 104 then transmits the integrated display data by way of communication line 5 to user terminal device 2 as image information.

When information communication unit 26 receives the image information, control unit 28 of user terminal device 2 supplies this image information to display unit 24. Display unit 24 displays an image, which shows the field of vision of the character that corresponds to user terminal device 2, according to the supplied image information, whereby the user of user terminal device 2 is able to see the character that corresponds to user terminal device 3. The user of user terminal device 2 is thus able to act together with the character that corresponds to user terminal device 3.

In addition, when command data are supplied from user terminal device 2, display control unit 104 transmits these supplied command data to three-dimensional city display unit 102 and character position management unit 103.

Character position management unit 103 controls the actions of the character, which corresponds to user terminal device 2, in accordance with the supplied command data. For example, upon receiving the command data “open the door,” character position management unit 103 generates moving picture data, which indicate the action of opening a door by the hand of the character that corresponds to user terminal device 2. Character position management unit 103 then supplies these generated moving picture data to display control unit 104.

Three-dimensional city display unit 102 controls the display of the virtual city in accordance with the supplied command data. For example, when three-dimensional city display unit 102 receives the command data “open the door,” three-dimensional city display unit 102 generates moving picture data that indicate the action of opening the door close to the character that corresponds to user terminal device 2. Three-dimensional city display unit 102 then supplies these generated moving picture data to display control unit 104.

Display control unit 104 integrates the moving picture data, which have been supplied from three-dimensional city display unit 102, and the moving picture data, which have been supplied from character position management unit 103. Display control unit 104 supplies these integrated display data as image information to user terminal device 2 by way of communication line 5.

Display unit 24 of user terminal device 2 thus displays an action that is similar to an action carried out by a real person. Thus, when the user of a user terminal device goes shopping in a book store in a virtual city, the user can cause the character to pick up a book, and further, can even cause a character to take the book to the store register. In this way, the user can actually enjoy the experience of shopping on the screen.

In Step 71, character position management unit 103 constantly supplies communication control unit 105 with the positions ([X, Y, Z] coordinates) of each of the characters that correspond to the user terminal devices 2 and 3 that are logged into server 1.

When communication control unit 105 is supplied with the position ([X, Y, Z] coordinates) of each character from character position management unit 103, communication control unit 105 executes Step 72.

In Step 72, communication control unit 105 controls the communication between each of the user terminal devices based on the supplied positions ([X, Y, Z] coordinates) of the characters.

More specifically, communication control unit 105, or more exactly, determination unit 105a, uses the (X, Y, Z) coordinates of each character in order to monitor whether other characters are in a prescribed sphere that takes as its center the position of a particular character. The prescribed sphere is the area surrounding a prescribed character.

FIG. 7 is an explanatory view showing an example of a prescribed sphere that takes the position of a particular character as its center. In FIG. 7, prescribed sphere 701 is a sphere that takes character 101 as its center.

When determination unit 105a determines that another character is within the prescribed sphere that takes the position of the particular character as its center, information communication control unit 105b permits the communication of information between the information communication unit of the user terminal device, which corresponds to the particular character, and the information communication unit of the user terminal device, which corresponds to the other character.

Information communication control unit 105b further automatically puts into effect the speech conference function that is realized between the information communication unit of the user terminal device, which corresponds to the particular character, and the information communication unit of the user terminal device, which corresponds to the other character.

When the speech conference function, which is realized between the information communication unit of the user terminal device that corresponds to the particular character and the information communication unit of the user terminal device that corresponds to the other character, is put into effect, speech, which is received by the microphone of the user terminal device that corresponds to the other character, is supplied from the speaker of the user terminal device that corresponds to the particular character. At the same time, speech, which is received at the microphone of the user terminal device that corresponds to the particular character, is supplied from the speaker of the user terminal device that corresponds to the other character.

Moreover, when determination unit 105a determines that another character is within the prescribed sphere that takes the particular character as its center, information communication control unit 105b also enables the use of the whiteboard function, the application share function, the file transfer function, and the video conference function between the information communication unit of the user terminal device, which corresponds to the particular character, and the information communication unit of the user terminal device that corresponds to the other character.

In cases when the user of the user terminal device that corresponds to a particular character and the user of the user terminal device that corresponds to another character use the above-described functions, the users click on the execution buttons having the appropriate functions that are displayed on the user terminal devices. The execution buttons are show on the Web browser by HTML.

When the execution button with the appropriate function, which is displayed on the user terminal devices, is clicked on, information communication control unit 105b transmits a screen (HTML), which shows each function, to each user terminal device. Each user terminal device presents a pop-up display of the transmitted screen. The above-described functions are executed based on these pop-up screens.

When determination unit 105a determines that another character is not within the prescribed sphere that takes the position of a particular character as its center, information communication control unit 105b prohibits the communication of information between the information communication unit of the user terminal device, which corresponds to the particular character, and the information communication unit of the user terminal device, which corresponds to the other character, whereby the above-described functions are prohibited. When the user of a user terminal device performs a transaction such as the purchase of an article that is offered by seller terminal device 4, the user operates his or her user terminal device in order to supply his or her log-in ID to seller terminal device 4.

The user of seller terminal device 4 enters the supplied log-in ID to the screen that is displayed on the browser of seller terminal device 4 and then clicks on the execution button that is displayed in the browser of seller terminal device 4. When the execution button is clicked on, seller terminal device 4 supplies the entered log-in ID to server 1.

Credit card transaction unit 106 of server 1 specifies the user based on the supplied log-in ID. Credit card transaction unit 106 then transmits an HTML document of the credit card number input screen to the user terminal device of the specified user.

Upon receiving the HTML document, the user terminal device causes the credit card number input screen to pop up on the browser.

The user enters his or her credit card number in the credit card number input screen, and the user terminal device, upon entry of the credit card number, supplies the entered credit card number to seller terminal device 4.

Seller terminal device 4 performs the transaction based on the supplied credit card number.

If the credit card number of the user has been registered beforehand in client database 16, seller terminal device 4 may also acquire the user's credit card number from client database 16 based on the supplied log-in ID. In this case, the user need not report his or her credit card number to seller terminal device 4 each time a transaction is carried out, and the speed of the transaction can be improved accordingly.

When the user clicks on the log-out button that is displayed in the browser of the user terminal device, authentication unit 101 performs processing for logging out, and further, deletes the user that has logged out from the logged-in list.

In addition, the manager of server 1 is able to manage information and the status of users who are logged in by using client database 16. The manager of server 1 is therefore able to improve the user support system and the security of server 1 based on user information.

The present embodiment is not limited to applications to the field of electronic transactions, and can, for example, be used in the fields of education or entertainment.

As an example, establishing an educational location such as an English conversation school or a qualification school in the three-dimensional city enables the provision of a service from the virtual city sa if it were the real world. If an English conversation school is established, people who have paid fees to this school can participate in the school, which is provided at a specific location in the virtual city, and can receive education by way of each of the functions such as the speech conference function, whiteboard function, and application share function.

If a school is established in the three-dimensional city, the administrators of the school can reduce such fixed expenses as school rental charges.

In addition, the users are able to receive the following benefits:

Student education expenses can be reduced through both the reduction of commuting expenses and the lowering of school fees that results from the reduction of the fixed expenses for the operating the school.

In addition, even when dealing with a busy schedule, a user can participate in school from any location as long as he or she has a user terminal device. Still further, a real-world entertainment facility such as an amusement park or a game center can be established in a three-dimensional city. In this case, users in different locations can together enjoy the same entertainment facilities. In addition, the operators of an entertainment facility can obtain a reduction of fixed expenses such as space rental charges and can therefore offer services to the user at a lower price.

In addition, the virtual space is not limited to three-dimensional space and can be varied as appropriate, for example, taking the form of two-dimensional space.

The area surrounding a character is further not limited to the area of a sphere having a prescribed radius that takes the character as its center, and may be modified as appropriate.

Still further, the virtual space is not limited to a city that corresponds to an actually existing space, and may be a space that indicates a city or space that does not actually exist.

According to the present embodiment, when another character is in an area surrounding a prescribed character, communication of information is permitted between the information communication unit of the user terminal device, which corresponds to the prescribed character, and the information communication unit of the user terminal device, which corresponds to the other character. On the other hand, when another character is not in the area surrounding a prescribed character, the communication of information is prohibited between the information communication unit of the user terminal device that corresponds to the prescribed character and the information communication unit of the user terminal device that corresponds to the other character. Accordingly, the user of the user terminal device, which corresponds to the prescribed character, is able to engage in communication in virtual space that resembles communication in the real world, specifically, communication with people close to the user, which are users of user terminal devices that correspond to the other characters.

While preferred embodiments of the present invention have been described using specific terms, such description is for illustrative purposes only, and it is to be understood that changes and variations may be made without departing from the spirit or scope of the following claims.

1. A virtual space-providing system, said virtual space-providing system including: a plurality of user terminal devices; and a virtual space-providing server that places a different character in correspondence with each of said user terminal devices, stores these correspondences, and, upon receiving connection requests from said user terminal devices by way of a communication line, arranges in virtual space the characters that correspond to the user terminal devices that supplied the connection requests, and then provides to each of said plurality of user terminal devices image information by way of a communication line, this image information indicating images that surround the characters that correspond to each user terminal device; wherein:
each of said plurality of user terminal devices includes an information communication unit; and
said virtual space-providing server comprises:
a character position management unit for managing positions of each of said plurality of characters in said virtual space;
a determination unit for determining, based on the positions of each of said plurality of characters in said virtual space that are managed by said character position management unit, whether or not another character is in an area surrounding a prescribed character that is any one of said plurality of characters; and
an information communication control unit for, when said determination unit has determined that another character is within the area surrounding said prescribed character, permitting communication of information between the information communication unit of the user terminal device that corresponds to said prescribed character and the information communication unit of the user terminal device that corresponds to said other character; and when said determination unit has determined that another character is not within the area surrounding said prescribed character, prohibiting the communication of information between the information communication unit of the user terminal device that corresponds to said prescribed character and the information communication unit of the user terminal device that corresponds to another character.

2. A virtual space-providing system according to claim 1, wherein said information communication unit communicates speech information.

3. A virtual space-providing system according to claim 1, wherein said information communication unit communicates moving picture information.

4. A virtual space-providing system according to claim 1, wherein said information communication unit communicates still picture information.

5. A virtual space-providing system according to claim 1, wherein said information communication unit communicates speech information, moving picture information, and still picture information.

6. A virtual space-providing system according to claim 1, wherein said virtual space-providing server causes characters that are arranged in said virtual space to move based on movement instruction requests that are supplied from user terminal devices that correspond to these characters.

7. A virtual space-providing server, said server, upon receiving by way of a communication line connection requests from each of user terminal devices that are each provided with an information communication unit, arranging, in virtual space, the characters that correspond to the user terminal devices that supplied the connection requests, and then providing, by way of a communication line to each of said plurality of user terminal devices, image information that indicates images in vicinities of the characters that correspond to each user terminal device; said virtual space-providing server comprising:
a character position management unit for managing positions in said virtual space of each of said plurality of characters;
a determination unit for determining, based on the positions of each of said plurality of characters in virtual space that are managed by said character position management unit, whether or not another character is in an area surrounding a prescribed character that is any one of said plurality of characters; and
an information communication control unit for, when said determination unit has determined that another character is in the area surrounding said prescribed character, permitting communication of information between the information communication unit of the user terminal device that corresponds to said prescribed character and the information communication unit of the user terminal device that corresponds to said other character, and when said determination unit has determined that another character is not in the area surrounding said prescribed character, prohibiting the communication of information between the information communication unit of the user terminal device that corresponds to said prescribed character and the information communication unit of the user terminal device that corresponds to said other character.

8. A virtual space-providing method, said virtual space-providing method being carried out by a virtual space-providing system that includes: a plurality of user terminal devices; and a virtual space-providing server that places a different character that corresponds to each of said user terminal devices, stores these correspondences, and, upon receiving connection requests from each of said user terminal devices by way of a communication line, arranges in virtual space the characters that correspond to the user terminal devices that supplied the connection requests, and then provides to each of said plurality of user terminal devices image information by way of a communication line, this image information indicating images that surround the characters that correspond to each user terminal device; said plurality of user terminal devices each including an information communication unit, said virtual space-providing method comprising:
a character position management step in which said virtual space-providing server manages positions of said plurality of characters within said virtual space;
a determination step in which said virtual space-providing server, based on said positions of the plurality of characters within virtual space, determines whether another character is in an area surrounding a prescribed character that is any one of said plurality of characters; and
an information communication control step in which, when another character is in the area surrounding said prescribed character, said virtual space-providing server permits communication of information between the information communication unit of the user terminal device that corresponds to said prescribed character and the information communication unit of the user terminal device that corresponds to said other character; and when another character is not in the area surrounding said prescribed character, said virtual space-providing server prohibits the communication of information between the information communication unit of the user terminal device that corresponds to said prescribed character and the information communication unit of the user terminal device that corresponds to said other character.

9. A virtual space-providing method according to claim 8, wherein the communication of information between the information communication unit of the user terminal device that corresponds to said prescribed character and the information communication unit of the user terminal device that corresponds to said other character is the communication of speech information.

10. A virtual space-providing method according to claim 8, wherein the communication of information between the information communication unit of the user terminal device that corresponds to said prescribed character and the information communication unit of the user terminal device that corresponds to said other character is the communication of moving picture information.

11. A virtual space-providing method according to claim 8, wherein the communication of information between the information communication unit of the user terminal device that corresponds to said prescribed character and the information communication unit of the user terminal device that corresponds to said other character is the communication of still picture information.

12. A virtual space-providing method according to claim 8, wherein the communication of information between the information communication unit of the user terminal device that corresponds to said prescribed character and the information communication unit of the user terminal device that corresponds to said other character is the communication of speech information, the communication of moving picture information, and the communication of still picture information.

13. A virtual space-providing method, said virtual space-providing method being carried out by a virtual space-providing server that, upon receiving by way of a communication line connection requests from each of user terminal devices that are each provided with an information communication unit, arranges in virtual space characters that correspond to the user terminal devices that supplied the connection requests, and then provides to each of said plurality of user terminal devices image information by way of a communication line, this image information indicating images that surround the characters that correspond to each user terminal device; said virtual space-providing method comprising the steps of:
managing positions of said plurality of characters within said virtual space;
determining whether another character is in area surrounding a prescribed character that is any one of said plurality of characters based on said positions of the plurality of characters within virtual space; permitting communication of information between the information communication unit of the user terminal device that corresponds to said prescribed character and the information communication unit of the user terminal device that corresponds to said other character when another character is present in the area surrounding said prescribed character; and
prohibiting the communication of information between the information communication unit of the user terminal device that corresponds to said prescribed character and the information communication unit of the user terminal device that corresponds to said other character when another character is not present in the area surrounding said prescribed character.

14. A virtual space-providing method according to claim 8, further including a step for moving characters in which said virtual space-providing server moves characters that are arranged in said virtual space based on movement instruction requests that are supplied from user terminal devices that correspond to the characters.

15. A virtual space-providing method according to claim 13, further comprising a character moving step of moving characters that are arranged in said virtual space based on movement instruction requests that are supplied from the user terminal devices that correspond to the characters.
